(19) United States
(12) Patent Application Publication
(10) Pub. No.: US 2024/0177690 A1
(43) Pub. Date: May 30, 2024

(54) FUNCTIONAL SAFETY DISPLAY CONTROLLER

(71) Applicant: NXP USA, Inc., Austin, TX (US)

(72) Inventors: Michael Andreas Staudenmaier, Munich (DE); Iani Bogdan Almajan, Bragadiru (RO); Vincent Aubineau, Issy-les-Moulineaux (FR)

(21) Appl. No.: 18/302,272

(22) Filed: Apr. 18, 2023

(30) Foreign Application Priority Data
Nov. 24, 2022 (RO) A202200768

(51) Int. Cl. G09G 5/18

(52) U.S. Cl. CPC G09G 5/18; G09G 2330/12; G09G 2370/00

(57) ABSTRACT

A method for controlling a functional safety display controller including defining in a display controller, a visible display area of a display device, wherein the display device is configured to raster scan a series of pixel intensity data, the raster scan including at least one synchronization phase. A test area of the display device is defined to be mutually exclusive of the visible display area. A test data is rendered in the test area to generate a rendered test data during the at least one synchronization phase of the raster scan. A checksum of the rendered test data is generated. The checksum is compared with a previously generated checksum to verify a functionality of the display controller.

### FIELD

This disclosure relates generally to a display controller, and more specifically to reliably controlling the display of safety-related image content combined with variable image content.

### BACKGROUND

In safety critical environments, the integrity of displayed information must be ensured. This ensures that a user of this information does not respond to errant information in a way that may cause a hazard. For example, automotive displays often display safety critical information such as a rendered needle of the speed indicator, gear selection or a critical warning message in combination with less critical information such as navigation, entertainment or a video feed. Hardware or software faults in a display system may lead to corruption of the safety critical information.

In particular, automotive displays are often required to meet at least the Automotive Safety Integrity Level B (ASIL-B) as defined by the ISO 26262 standard. Traditionally, ensuring automotive display integrity required knowledge of the displayed content prior to generating a checksum of the displayed output. This prevented the combination of non-safety related images (e.g., camera input) with safety-related image content (e.g., telltales), thereby requiring the separation of image content in time or space.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is a graphical view of an example of a raster scan.

FIG. 2 is a graphical view of synchronization pulses of a functional safety display controller, in accordance with example embodiments of the present disclosure.

FIG. 3 is a functional block view of a functional safety display controller, in accordance with example embodiments of the present disclosure.

FIG. 4 is another functional block view of a functional safety display controller, in accordance with example embodiments of the present disclosure.

FIG. 5 is another functional block view of a functional safety display controller, in accordance with example embodiments of the present disclosure.

FIG. 6 is another functional block view of a functional safety display controller, in accordance with example embodiments of the present disclosure.

FIG. 7 is a flowchart representation of a method for a functional safety display controller, in accordance with example embodiments of the present disclosure.

FIG. 8 is a flowchart representation of a timeline of FIG. 7 for a functional safety display controller, in accordance with example embodiments of the present disclosure.

FIG. 9 is a flowchart representation of another method for a functional safety display controller, in accordance with example embodiments of the present disclosure.

FIG. 10 is a flowchart representation of another method for a functional safety display controller, in accordance with example embodiments of the present disclosure.

### DETAILED DESCRIPTION

Embodiments described herein provide for verification of the integrity of displayed information by periodically testing the functionality of a display controller used to display such information. The integrity is verified with specific test patterns during one or more synchronization phases of a raster scan display thereby avoiding the requirement to generate a checksum of non-safety related images in advance of displaying such data.

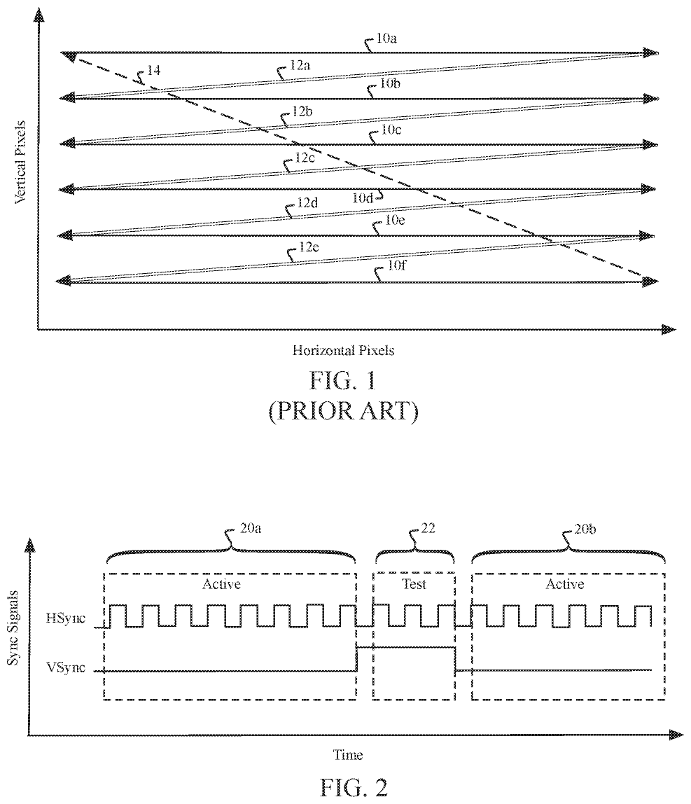

FIG. 1 shows an example of a raster scan, similar to that used in Cathode Ray Tube (CRT) displays. In a raster scan, serialized pixel intensity data are first displayed in the upper left corner of FIG. 1, progressing to the right along the vector 10a. After reaching the end of vector 10a, the CRT is repositioned to the left side again, and incrementing down one line, during a Horizontal Synchronization (HSync) phase 12a. The process repeats by alternating between vectors 10a, 10b, 10c, 10c, 10d, 10e and 10f (generally 10), with respective HSync phases 12a, 12b, 12c, 12d, 12e and 12f (generally 12). Once the CRT reaches the end of the last display line at the bottom right corner, the display is reset to the top left starting point during a Vertical Synchronization (VSync) phase 14.

FIG. 2 with continued reference to FIG. 1 shows HSync and VSync pulses, (coincident with the respective HSync and VSync phases of FIG. 1), used in example embodiments of the present disclosure. Specifically, during an active phase 20a or 20b, a plurality of HSync pulses are generated, each one synchronizing the rastered pixel intensity data between the horizontal extremities of the display (e.g., from the left to the right in FIG. 1). It should be understood that the rastering of FIG. 1 may be mirrored in the vertical axis, horizontal axis or both with similar effect. Additionally, the raster scan may be extended beyond CRTs to include other serialized data displays not based on tube technologies. Pixel intensity data are displayed as visible display data in a visible display area of a display device in between each of the HSync pulses of FIG. 2. A test phase 22 coincides with the VSync phase, during which test data are transmitted to a test area (e.g., an invisible area or an area that is not presented to the user) of the display device, rather than transmitting and displaying visible pixel intensity data. In another embodiment, the test data is transmitted during one or more of the HSync pulses. In another embodiment, the test data is transmitted during a combination of the one or more HSync pulses and the VSync pulse.

Accordingly, a display controller may use the HSync pulses, VSync pulses or both the HSync and VSync pulses to process test data to verify the functionality of the display controller. The test data may be chosen to achieve the reliability level (e.g., ASIL-B) required according to the functional safety level of the display application. Advantageously, the test data may be fetched from a storage device, during a time when minimal communication occurs between the display controller and the storage device, and thus maximum memory bandwidth is available.

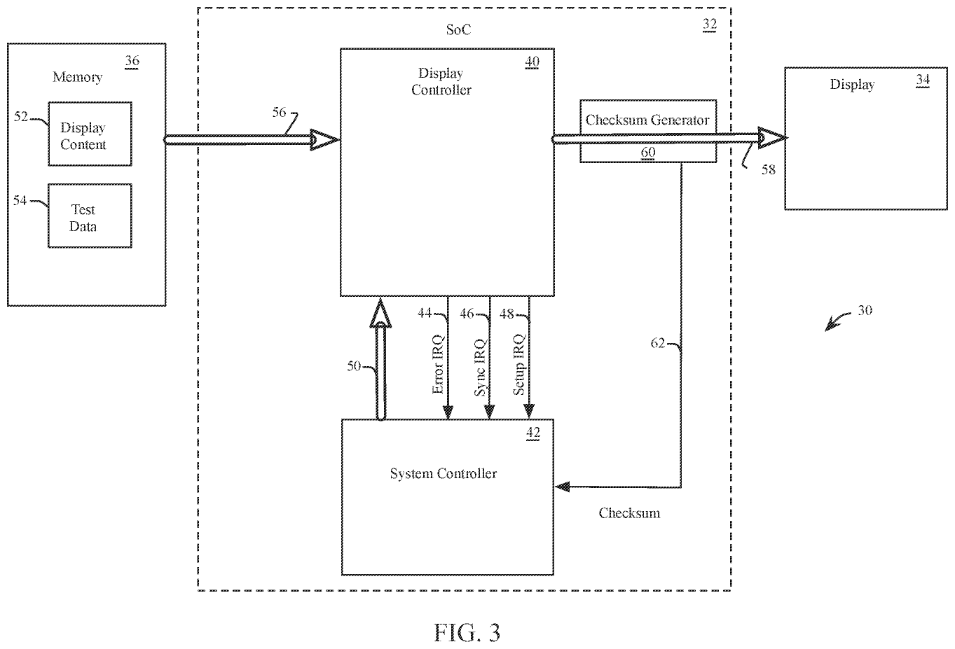

FIG. 3 shows a functional block view of a functional safety display controller 30, in accordance with example embodiments of the present disclosure. The controller 30 may include a System-On-A-Chip (SoC) (e.g., a semiconductor device) 32, a display device 34 and a memory (e.g., storage device) 36. The SoC 32 may include a display controller 40 and a system controller 42. The display controller 40 may generate an Error Interrupt Request (Error IRQ) 44, received by the system controller 42. In one embodiment, the Error IRQ 44 may indicate a buffer underrun situation, wherein the display controller 40 requires display data at a rate faster than the display data is being provided. In other embodiments, the display controller 40 may include multiple Error IRQ 44 to flag a variety of errors. The display controller 40 may also generate a Synchronization Interrupt Request (Sync IRQ) 46, which may correspond to an HSync, a VSync or may be a pair of connections including both the HSync and VSync, as described with respect to FIG. 2. Embodiments that use the VSync phase to generate and compare test data may incur less context switching of the display controller 40, compared to using a plurality of HSync pulses, however both approaches are realizable and envsioned within this disclosure. The display controller 40 may also generate a Setup Interrupt Request (Setup IRQ) 48 to request the system controller 42 to provide to the display controller 40 over a bus 50, the visible display area or the test area, discussed with respect to FIG. 2.

The visible display area corresponds to an address space in the memory 36 transmitted by the display controller 40 and used to generate a visible picture on the display device 34. The test area is an invisible area transmitted by the display controller 40 during a synchronization phase (e.g., VSync or HSync or both), to verify the functionality of the display controller 40. In one embodiment, the display controller receives the visible display content 52 and the test data 54 from the memory 36 over a bus 56.

In one embodiment, the display controller 40 renders and transmits both the visible display content 52 and the test data 54 to the display device 34 over a bus 58. A checksum generator 60 may generate a checksum 62 of the rendered test data 54, transmitted by the display controller 40. In one embodiment, the system controller 42 may also compare the checksum 62 received by the checksum generator 60 with a checksum defined offline during an initialization phase prior to displaying the visible display content 52. Advantageously, a predefined checksum guards against a permanent fault that may exist when the display controller is initially activated or powered-on. In one embodiment, the predefined checksum is determined during development of the functional safety display controller using one or more parameters including without limit, a seed value of a Pseudo Random Number Generator and a configuration of the display controller 40. In another embodiment, more than one predefined checksums may be used based on more than one seed values or one or more display configurations.

In another embodiment, the system controller 42 may also compare the checksum 62 received from the checksum generator 60 with a previous checksum generated by test data previously rendered by the display controller 40. In one embodiment, the previous checksum may be stored in the system controller 42.

A failed comparison of the checksum 62 may indicate a fault with the functionality of the display controller 40. In one embodiment, the checksum generator 60 may generate a checksum 62 based on a subset of the test data 54, and the system controller 42 may similarly compare the checksum 62 to a previous checksum based on the corresponding subset of the test data 54.

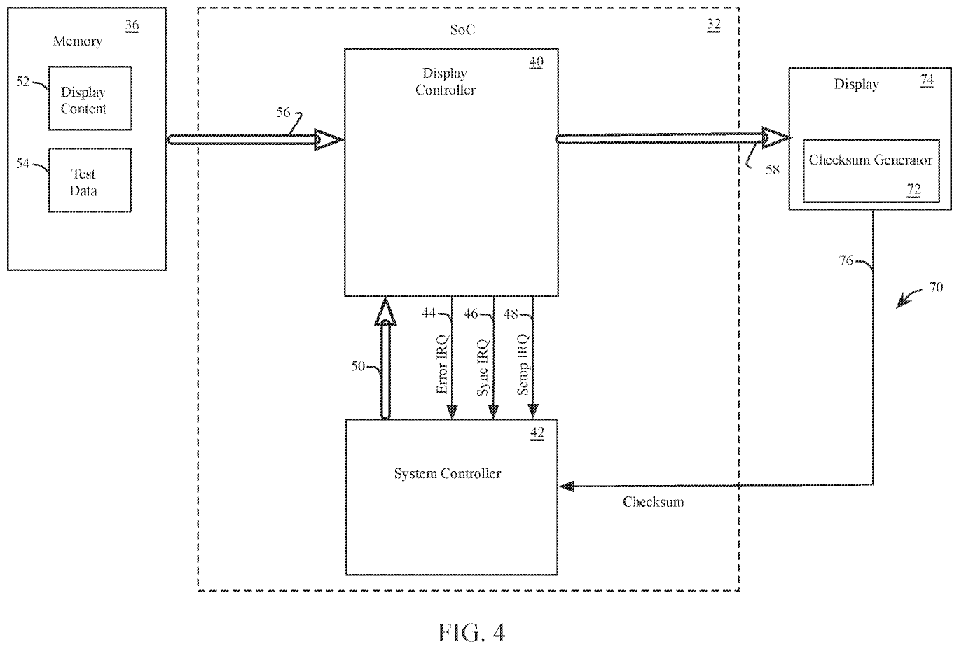

FIG. 4 shows a functional block view of a functional safety display controller 70, in accordance with example embodiments of the present disclosure. FIG. 4, with continued reference to FIG. 3, shows the checksum generator 72 is integrated with the display device 74 to generate the checksum 76. Accordingly, the checksum 76 may now be used to determine functionality issues with the display controller 40 as well as the bus 58. This additional coverage may be advantageous particularly where the bus 58 is very long and supported by in-line transceivers (not shown). In one embodiment, the checksum generator 72 is the same as the checksum generator 60. In another embodiment, the checksum generator 72 is modified from the checksum generator 60 to limit the generation of the checksum 76 to a subset of the test data only.

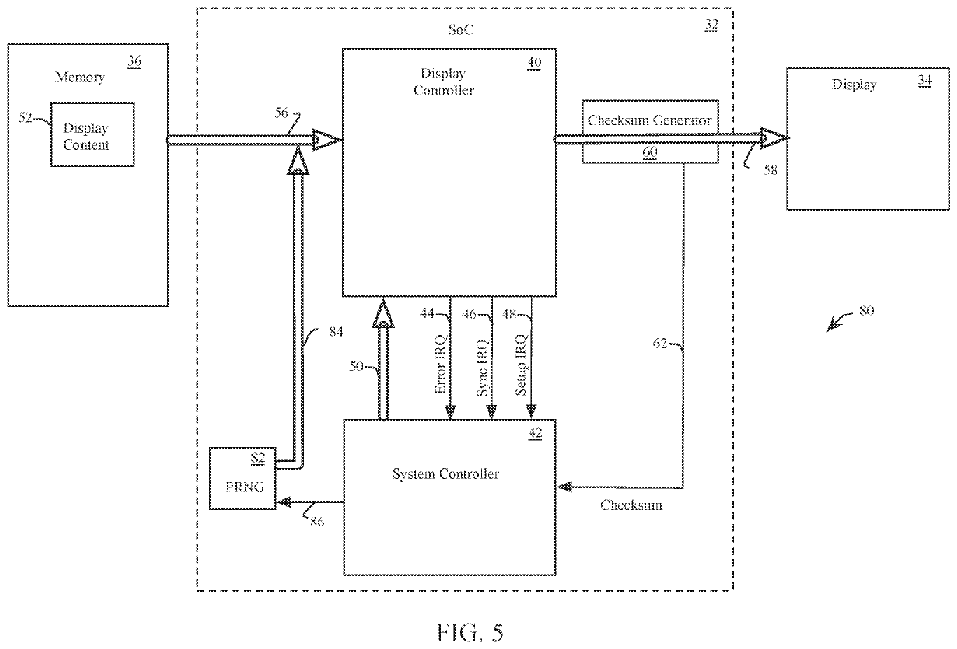

FIG. 5 shows another functional block view of a functional safety display controller 80, in accordance with example embodiments of the present disclosure. FIG. 5, with reference to FIG. 3 replaces the test data 54 previously stored in the memory 36 with a Pseudo Random Number Generator (PRNG) 82. Advantageously, the use of the PRNG eliminates memory bandwidth consumption during the synchronization pulse (or pulses) used to verify the display controller and reduces storage requirements of the memory 36. The PRNG 82 transmits a generated test data over a bus 84 to the display controller 40. The PRNG 82 further requires a start seed 86 generated by the system controller 42.

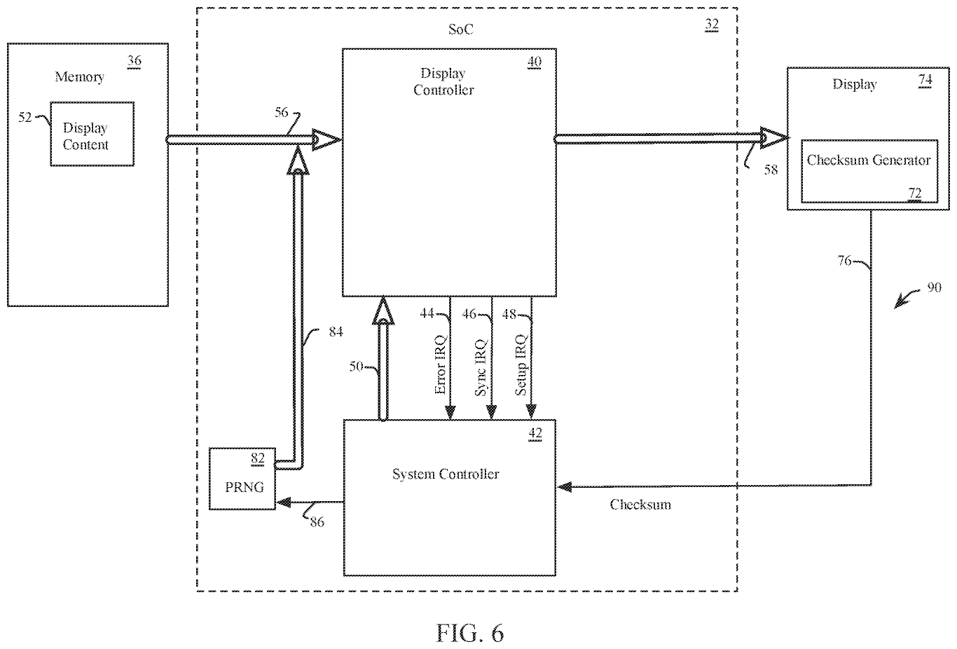

FIG. 6 shows another functional block view of a functional safety display controller 90, in accordance with example embodiments of the present disclosure. FIG. 6 implements the PRNG 82 of FIG. 5 with the checksum generator 72 integrated with the display 74, (as also shown in FIG. 4). Accordingly, the test data generated by the PRNG 82 verifies the functionality of the display controller 40 in addition to the bus 58.

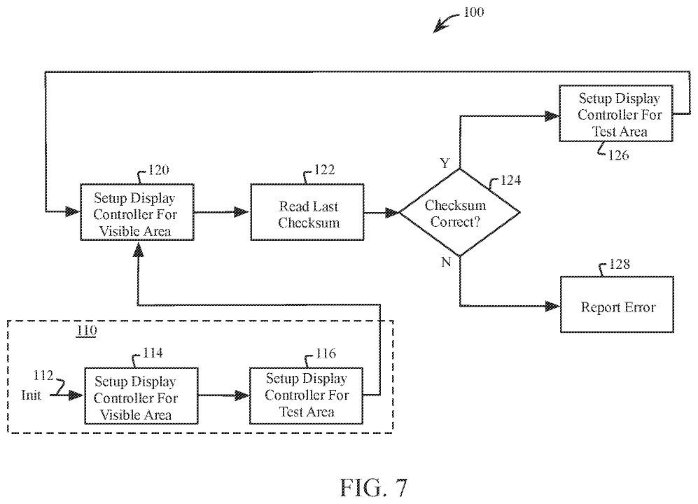

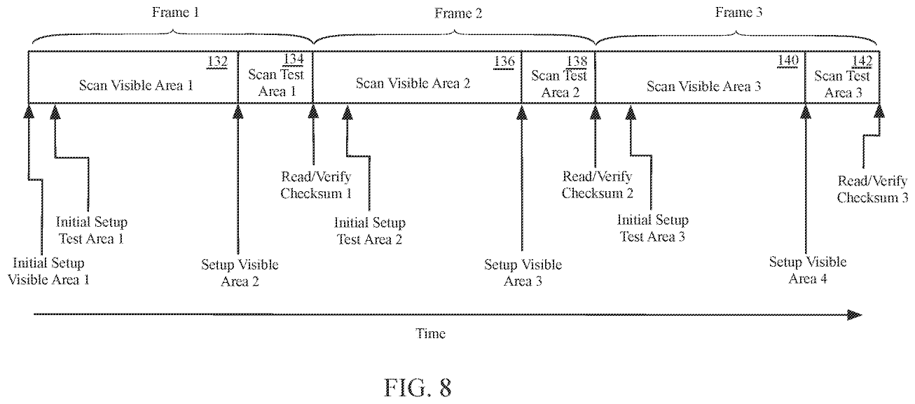

FIG. 7 is a flowchart representation of a method 100 for a functional safety display controller, in accordance with example embodiments of the present disclosure. FIG. 8 shows a timeline of FIG. 7 to further illustrate the method 100. With reference to both FIG. 7 and FIG. 8, the method 100 includes an initiation step 110. In one embodiment, the initiation step 110 defines a visible display area (visible display area 1) for the display controller at step 114. The initiation step 110 then defines an invisible test area (test area 1) for the display controller at step 116. In another embodiment, the step 116 may occur prior to, or be concurrent with, the step 114. The terms “display”, “scan” and “raster scan” are interchangeable and equivalent as used herein.

Following the initiation step 110, the visible display area 1 is displayed at 132. Subsequently at 120, the next visible display area 2 is setup. At 134, the test area 1 is raster scanned, then a checksum 1 of the first test area 1 is read at 122 and compared at 124 to a previously generated checksum to determine an integrity of the display controller 40. In one embodiment, the scanning of the test area 1 at 134 may temporally overlap with the setup of the visible area 2.

If the comparison at 124 is true, indicating that the last checksum 1 is the same as a previous generated checksum (e.g., the previously discussed predefined checksum), then the display controller 40 is deemed to be functional with sufficient integrity. If the comparison at step 124 is false, then an error is reported at 128. Some examples of error reporting at 128 include, but are not limited to, setting a system flag or activating a light or other visual or auditory signal to a user of the functional safety display controller. In one example, the error is reported to a functionally higher level system, which then sets itself into a safe state. For example, in the case of a display, the display may be switched off, a warning light may illuminate or an acoustic warning may be activated.

If the comparison at 124 is true, the next test area 2 is set up at 126, while the next visible display area 2 is scanned at 136. In so doing, the visible area and the test area are each setup well before the display controller 40 requires this information, thereby relaxing the timing requirements of the System Controller 42. Specifically, with reference to FIG. 8, the visible area is setup between 132 and 134, well before the visible area 2 is scanned at 136. The test area 2 may be setup during the scan of the visible area 2 at 136, well before the test rea 2 is scanned at 138. Following step 126, the visible display area 3 is setup by returning to step 120. Steps 138 and 140 follow a similar flow to steps 134 and 136 respectively. Step 142 follows a similar flow to step 134 or 138. It should be understood that sequential numeric references to the visible display areas 1, 2 and 3, and the test areas 1, 2 and 3 are provided for ease of understanding and are not intended as limitations on the disclosure.

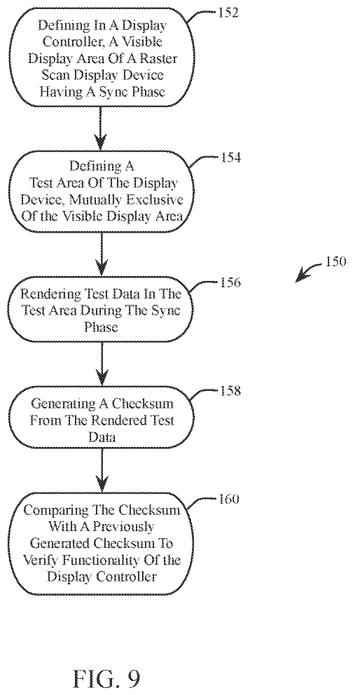

FIG. 9 shows an embodiment 150 of a method for controlling a functional safety display controller. With continued reference to FIG. 3, FIG. 7 and FIG. 8, at 152 in a display controller 40, a visible display area of a raster scan display device 34 is defined 120, wherein the raster scan display device has a sync pulse (VSync, HSync, or both). Subsequently, a visible image is rendered and displayed. At 154, a test area of the display device is defined 126. The visible display area and the test area are mutually exclusive. At 156, the test data 54 is rendered during the synch phase 20. At 158, a checksum 62 is generated from the rendered test data. At 160, the checksum is compared 124 with a previously generated checksum to verify the functionality of the display controller.

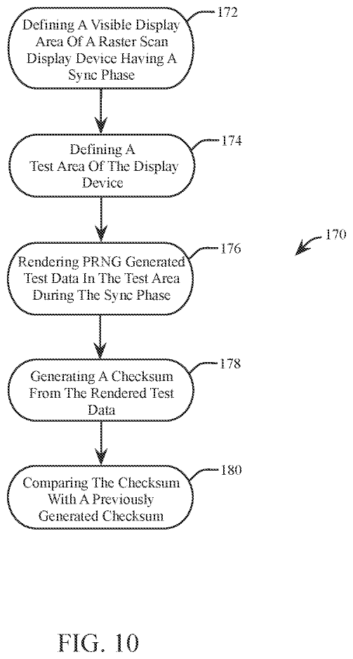

FIG. 10 shows an embodiment 170 of a method for controlling a functional safety display controller. With continued reference to FIG. 5, FIG. 7 and FIG. 8, at 172 a visible display area of a raster scan display device 34 is defined 120, wherein the raster scan display device has a sync pulse (VSync, HSync, or both). Subsequently, a visible image is rendered and displayed. At 174, a test area of the display device is defined 126. At 176, PRNG generated test data 84 is rendered during the synch phase 20. At 178, a checksum 62 is generated from the rendered test data. At 180, the checksum is compared 124 with a previously generated checksum.

As will be appreciated, at least some of the embodiments as disclosed include at least the following. In one embodiment, a method for controlling a functional safety display controller comprises defining in a display controller, a visible display area of a display device, wherein the display device is configured to raster scan a series of pixel intensity data, the raster scan comprising at least one synchronization phase. A test area of the display device is defined, mutually exclusive of the visible display area. A test data is rendered in the test area to generate a rendered test data during the at least one synchronization phase of the raster scan. A checksum of the rendered test data is generated. The checksum is compared with a previously generated checksum to verify a functionality of the display controller.

Alternative embodiments of the method for controlling a functional safety display controller include one of the following features, or any combination thereof. An error is reported in response to a difference between the checksum and the previously generated checksum. At least one of defining the visible display area and defining the test area is in response to a setup interrupt request generated by the display controller. The at least one synchronization phase comprises a vertical synchronization pulse. The at least one synchronization phase comprises a horizontal synchronization pulse. The at least one synchronization phase comprises a combination of a vertical synchronization pulse and a horizontal synchronization pulse. The functionality of the display controller meets at least a subset of the integrity requirements of an Automotive Safety Integrity Level B. The test data is predefined. The test data is generated by a Pseudo Random Number Generator.

In another embodiment, an apparatus comprises a display device, configured to raster scan a series of pixel intensity data, the raster scan comprising at least one synchronization phase. A system controller is configured to define a visible display area of the display device and a test area of the display device, wherein the test area is mutually exclusive of the display area. A display controller is configured to render a test data in the test area to generate a rendered test data. A checksum generator is configured to generate a checksum of the rendered test data, wherein the system controller compares the checksum with a previously generated checksum to verify a functionality of the display controller.

Alternative embodiments of the apparatus include one of the following features, or any combination thereof. A storage device is in electrical communication with the display controller and is configured to store the pixel intensity data and the test data. The pixel intensity data comprises a combination of safety-related image content and non-safety related image content. A semiconductor device comprises the system controller, the display controller and the checksum generator. The display device comprises the checksum generator. A Pseudo Random Number Generator is configured to generate the test data.

In another embodiment, a method for controlling a functional safety display controller comprises defining a visible display area of a display device, wherein the display device is controlled by a raster scan comprising at least one synchronization phase. A test area of the display device is defined. A test data is rendered in the test area to generate a rendered test data during the at least one synchronization phase of the raster scan, the test data generated by a Pseudo Random Number Generator (PRNG). A checksum of the rendered test data is generated. The checksum is compared with a previously generated checksum.

Alternative embodiments of the method for controlling a functional safety display controller include one of the following features, or any combination thereof. The checksum is compared with the test data to verify a functionality of the functional safety display controller. The visible display area and the test area are defined by a system controller in electrical communication with a display controller, the display controller configured to render a pixel intensity data for displaying on the display device. The system controller is configured to compare the checksum with a previously generated checksum. The system controller is configured to generate a start seed for the PRNG.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A method for controlling a functional safety display controller comprising:
defining in a display controller, a visible display area of a display device, wherein the display device is configured to raster scan a series of pixel intensity data, the raster scan comprising at least one synchronization phase;
defining a test area of the display device, mutually exclusive of the visible display area;
rendering a test data in the test area to generate a rendered test data during the at least one synchronization phase of the raster scan;
generating a checksum of the rendered test data; and
comparing the checksum with a previously generated checksum to verify a functionality of the display controller.

2. The method of claim 1 further comprising reporting an error in response to a difference between the checksum and the previously generated checksum.

3. The method of claim 1 wherein at least one of defining the visible display area and defining the test area is in response to a setup interrupt request generated by the display controller.

4. The method of claim 1 wherein the at least one synchronization phase comprises a vertical synchronization pulse.

5. The method of claim 1 wherein the at least one synchronization phase comprises a horizontal synchronization pulse.

6. The method of claim 1 wherein the at least one synchronization phase comprises a combination of a vertical synchronization pulse and a horizontal synchronization pulse.

7. The method of claim 1 wherein the functionality of the display controller meets at least a subset of the integrity requirements of an Automotive Safety Integrity Level B.

8. The method of claim 1 wherein the test data is predefined.

9. The method of claim 1 wherein the test data is generated by a Pseudo Random Number Generator.

10. An apparatus comprising:
a display device, configured to raster scan a series of pixel intensity data, the raster scan comprising at least one synchronization phase;
a system controller configured to define a visible display area of the display device and a test area of the display device, wherein the test area is mutually exclusive of the display area;
a display controller configured to render a test data in the test area to generate a rendered test data; and
a checksum generator configured to generate a checksum of the rendered test data, wherein the system controller compares the checksum with a previously generated checksum to verify a functionality of the display controller.

11. The apparatus of claim 10 further comprising a storage device in electrical communication with the display controller and configured to store the pixel intensity data and the test data.

12. The apparatus of claim 10 wherein the pixel intensity data comprises a combination of safety-related image content and non-safety related image content.

13. The apparatus of claim 10 wherein a semiconductor device comprises the system controller, the display controller and the checksum generator.

14. The apparatus of claim 10 wherein the display device comprises the checksum generator.

15. The apparatus of claim 10 further comprising a Pseudo Random Number Generator configured to generate the test data.

16. A method for controlling a functional safety display controller comprising:
defining a visible display area of a display device, wherein the display device is controlled by a raster scan comprising at least one synchronization phase;
defining a test area of the display device;
rendering a test data in the test area to generate a rendered test data during the at least one synchronization phase of the raster scan, the test data generated by a Pseudo Random Number Generator (PRNG);
generating a checksum of the rendered test data; and
comparing the checksum with a previously generated checksum.

17. The method of claim 16 wherein the checksum is compared with the test data to verify a functionality of the functional safety display controller.

18. The method of claim 16 wherein the visible display area and the test area are defined by a system controller in electrical communication with a display controller, the display controller configured to render a pixel intensity data for displaying on the display device.

19. The method of claim 18 wherein the system controller is configured to compare the checksum with a previously generated checksum.

20. The method of claim 18 wherein the system controller is configured to generate a start seed for the PRNG.
